(19) United States
(12) Patent Application Publication
(10) Pub. No.: US 2010/0253612 A1
(43) Pub. Date: Oct. 7, 2010

(54) DYNAMICALLY ESTABLISHED BACKLIGHT FOR ENERGY CONSERVATION IN LCD

(75) Inventors: Peter Shintani, San Diego, CA (US); William Joseph Clay, JR., San Diego, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/419,429

(22) Filed: Apr. 7, 2009

(51) Int. Cl. G09G 3/36; H04N 5/50

(52) U.S. Cl. 345/102; 348/731; 348/E05.097

(57) ABSTRACT

Backlighting lamps in an LCD are extinguished when they are in regions beyond the area of the demanded image produced by an associated LCD cell matrix that overlays the lamps. In some cases the size of the demanded image may be reduced according to a user-input energy savings mode and then lamps beyond the image region are extinguished. Energy savings are realized.

### I. FIELD OF THE INVENTION

The present invention relates generally to establishing backlighting in a liquid crystal display (LCD).

### II. BACKGROUND OF THE INVENTION

Some LCDs use backlighting in which the brightness of the backlight is varied according to ambient light levels in an effort to reduce energy consumption. For example the backlighting intensity can be reduced when the ambient light levels are low, because darker rooms require less backlighting than brighter rooms.

### SUMMARY OF THE INVENTION

As recognized herein, in addition to the energy savings that may be achieved using the method mentioned above, additional energy savings may be further achieved according to present principles.

Accordingly, a liquid crystal display (LCD) includes elongated co-planar lamps and a matrix of LCD cells juxtaposed with the lamps. The lamps provide backlighting for the matrix. Control circuitry controls the matrix to present a demanded image. The demanded image covers an image area, and the control circuitry maintains lamps outside the image area deenergized independently of ambient light conditions.

The lamps may be oriented vertically or horizontally. In example embodiments the control circuitry establishes an intensity of illumination for lamps within the image area based at least in part on ambient light conditions. In some implementations the control circuitry scales the image area in response to user input representing a desired energy use such that which lamps that are maintained deenergized are defined at least in part using the user input. In some examples the control circuitry includes a microprocessor and/or a display driver circuit.

In another aspect, a method includes providing backlighting lamps in an LCD, and extinguishing a subset of backlighting lamps in response to a determination that the subset of backlighting lamps is in regions beyond an area of a demanded image produced by an associated LCD cell matrix that overlays the lamps.

In another aspect, an apparatus has a TV tuner, control circuitry receiving a demanded image from the TV tuner, and a liquid crustal display (LCD) coupled to the control circuitry to present the demanded image. The control circuitry establishes a backlighting of the LCD in response to an area encompassed by the demanded image when displayed on the LCD.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram of one embodiment of a liquid crystal display (LCD) implemented in a TV environment;

FIG. 2 is a schematic diagram showing internal components of the TV shown in FIG. 1;

FIGS. 3 and 4 are schematic plan views of two embodiments of the backlighting lamps, illustrating some lamps deenergized when they lay outside the area of the demanded image;

FIG. 5 is a schematic plan view of the LCD showing various user-defined demanded image area sizes; and

FIGS. 6 and 7 are flow charts showing logic that may be used in accordance with present principles.

### DETAILED DESCRIPTION OF THE PREFERRED EMBODIMENT

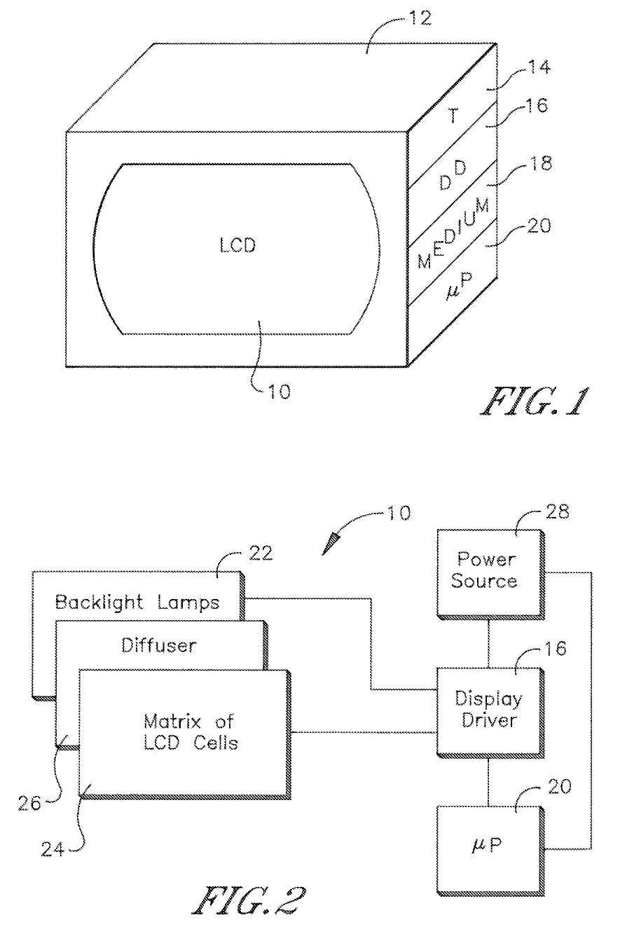

Referring initially to FIG. 1, an LCD 10 in accordance with present principles is shown embodied in one intended environment, namely, a TV 12 with TV tuner 14, display driver circuit 16 for driving the LCD 10, computer readable storage medium 18 such as disk-based or solid storage, and a microprocessor 20 accessing the medium 18 in accordance with logic set forth herein. The microprocessor 20 may control the display driver circuit 16 as appropriate to present the demanded image using the LCD 10, in which case the microprocessor 20 with display driver circuit 16 establish control circuitry. In other implementations the microprocessor 20/display driver circuitry 16 functionalities may be implemented by a single device.

The TV 12 may include inputs other than the TV tuner 14, e.g., the TV may receive video input from an optical disk player, a wide area computer network, etc. The LCD 10 may be used in other applications requiring video presentation, such as portable computers/portable communication devices, etc.

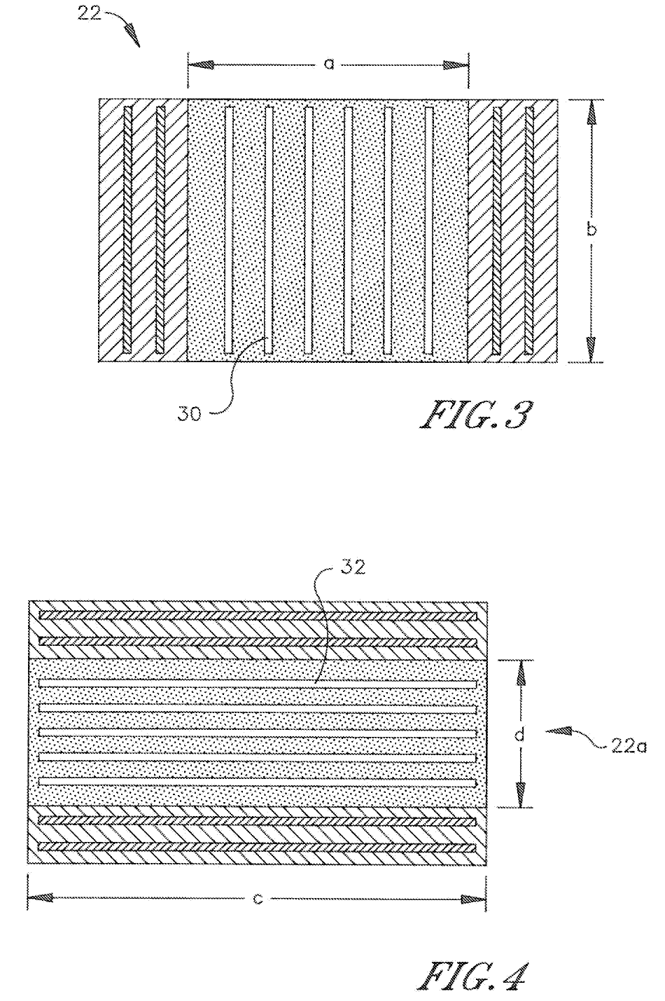

FIG. 2 shows that the LCD 10 may include a planar array 22 of backlight lamps as discussed further below. The array 22 provides backlighting for a matrix 24 of LCD cells that are controlled by the control circuitry to provide, in combination with the backlighting, a demanded image. Without limitation, the lamps in the array 22 can be light emitting diode (LED) lamps, hot cathode fluorescent (HCFL) lamps, and cold cathode fluorescent (CCFL) lamps.

Typically, a diffuser assembly 26 may be interposed between the backlighting array 22 and matrix 24 to diffuse backlight from the lamps onto the cells of the matrix. The components 22, 24, 26 typically establish three planes of components. A power source 28 is also typically provided to provide illumination power to the LCD 10 under control of the control circuitry.

In FIG. 3, details of an example array 22 of backlighting lamps 30 are shown. In the example shown in FIG. 3, the lamps 30 are elongated and oriented vertically when the display is positioned upright as shown in FIG. 1. The lamps 30 typically can be parallel to each other as shown.

In the example shown in FIG. 3, the overall dimension available for display of demanded images on the LCD 10 is 16×9, whereas the demanded image encompasses a 4:3 aspect ratio area defined by the dimensions “a” and “b” that is less than the available display area of the LCD 10. Lamps 30 that are beyond the area of the demanded image, in this case, lamps 30 that are beyond the boundaries of the dimension “a”, are maintained deenergized, while lamps 30 within the dimension “a” are energized to enable presentation of the demanded image. The deenergization of lamps 30 beyond the area of the demanded image is maintained regardless of whatever backlight dimming may be implemented within the dimension “a” to account for ambient light and/or demanded image pixel brightness. Thus, it is to be understood that present principles may be used to deenergize lamps 30 beyond the dimension “a” in conjunction with backlight control of lamps 30 within the dimension “a” to enhance energy savings.

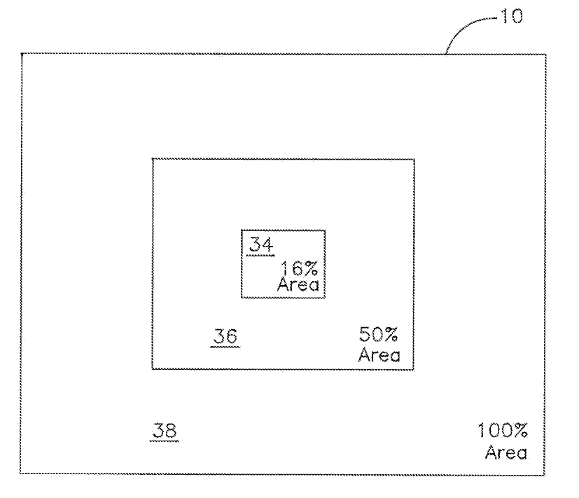

FIG. 4 shows an alternate array 22a of backlight lamps 32 that are horizontally oriented when the LCD is upright. In all other essential respects the arrays 22, 22a of FIGS. 3 and 4 are identical; thus, for example, when the overall dimension available for display of demanded images on the LCD 10 is 16×9 and the demanded image in a demanded image area defined by the dimensions “c” and “d” is in letterbox format, lamps 32 that do not underlie the area of the demanded image, i.e., lamps 32 beyond the dimension “d”, are maintained deenergized.

In addition to automatically deenergizing the lamps beyond an otherwise unmodified demanded image area, the control circuitry may scale the size of the demanded image in response to, e.g., user input. For example, a user interface maybe presented in a “setup” mode on the LCD that requests the user to select a desired energy savings mode. The mode may be established by numeric input, e.g., “save 80%”, or the user may be presented a menu of a limited number of options, e.g., “100%”, “50%”, “16%”. This latter implementation is illustrated in FIG. 5, in which the demanded image area is scaled down to a 16% image area 34 in response to the user effectively selecting “use ⅙ of the total available backlight power”. When the user selects “50%” the demanded image area is confined to area 36, while the full available screen—area 38—is used to present the demanded image in response to a “100%” selection. Backlighting lamps outside the selected area are maintained deenergized.

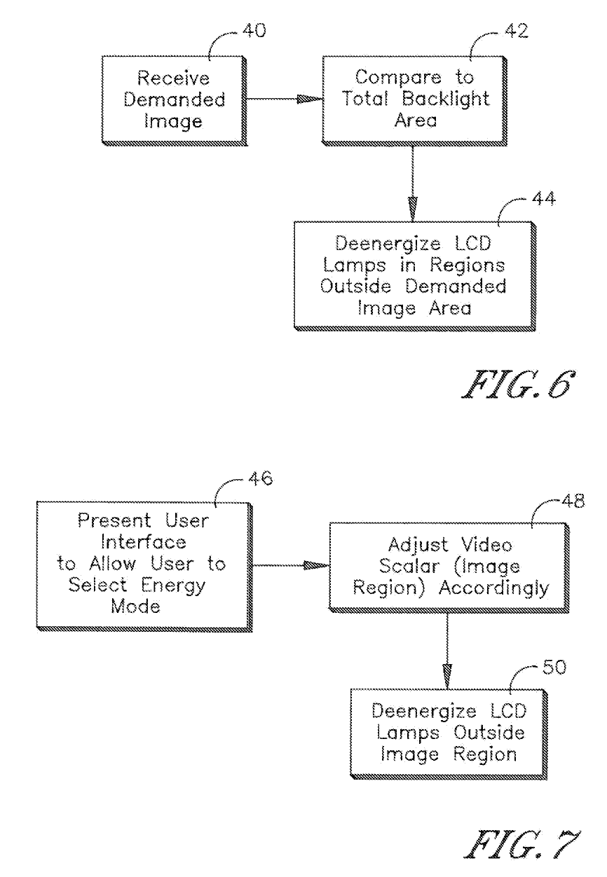

The above principles may be embodied by logic executable by the present control circuitry and illustrated in FIGS. 6 and 7. At block 40 in FIG. 6, a demanded image is received. Moving to block 42, the area of the demanded image is compared to the total area that may be backlit, and at block 44 lamps in regions that do not underlie the area of the demanded image are maintained deenergized.

In contrast, for the case in which image size can be scaled per user input and backlighting lamps deenergized accordingly, at block 46 in FIG. 7 a user interface may be presented to the user as described above to enable the user to select an energy savings mode. In essence, the user selects an image size, with smaller image sizes translating to lower energy use. The video scalar (and thus the size of the area occupied on screen by the demanded image) is adjusted according to the user input at block 48. Proceeding to block 50, LCD backlighting lamps that lie beyond the re-sized demanded image area are maintained deenergized.

Accordingly, it may now be appreciated that the speed of the addressable back light is not important for the power saving feature. The user may select the level of power savings required in some example embodiments, and the actively back lit area of the display is varied accordingly. In such embodiments the video scalar is also controlled so that the video content is scaled appropriately to match the area of the actively controlled back light area.

In some embodiments, recognizing that, as explained above, the demanded image area may not encompass the full screen area available for image presentation, the location of the demanded image on screen may be moved slightly from time to time, either randomly or in accordance with a time schedule. For instance, the demanded image in FIG. 3 may periodically be shifted one or a few pixels left or right, while the demanded image in FIG. 4 may be shifted one or a few pixels up or down. It may be appreciated that which lamps are energized and deenergized likewise change as necessary to backlight the current area of the demanded image while maintaining lamps deenergized that lie outside the current area of the demanded image.

While the particular DYNAMICALLY ESTABLISHED BACKLIGHT FOR ENERGY CONSERVATION IN LCD is herein shown and described in detail, it is to be understood that the subject matter which is encompassed by the present invention is limited only by the claims.

What is claimed is:

1. A liquid crystal display (LCD) comprising:
elongated co-planar lamps;
a matrix of LCD cells juxtaposed with the lamps, the lamps providing backlighting for the matrix; and
control circuitry controlling the matrix to present a demanded image, the demanded image covering an image area, the control circuitry maintaining lamps outside the image area deenergized independently of ambient light conditions.

2. The LCD of claim 1, wherein the lamps are oriented vertically.

3. The LCD of claim 1, wherein the lamps are oriented horizontally.

4. The LCD of claim 1, wherein the control circuitry establishes an intensity of illumination for lamps within the image area based at least in part on ambient light conditions.

5. The LCD of claim 1, wherein the control circuitry scales the image area in response to user input representing a desired energy use such that which lamps that are maintained deenergized are defined at least in part using the user input.

6. The LCD of claim 1, wherein the control circuitry includes at least one microprocessor.

7. The LCD of claim 1, wherein the image area is periodically shifted, the control circuitry changing which lamps are maintained deenergized in accordance with the image area.

8. Method comprising:
providing backlighting lamps in an LCD; and
extinguishing a subset of backlighting lamps in response to a determination that the subset of backlighting lamps is in regions beyond an area of a demanded image produced by an associated LCD cell matrix that overlays the lamps.

9. The method of claim 8, comprising reducing the size of the area of the demanded image according to a user-input energy savings mode.

10. The method of claim 8, comprising maintaining lamps outside the area of the demanded image deenergized independently of ambient light conditions.

11. The method of claim 8, comprising orienting the lamps vertically or horizontally.

12. The method of claim 8, comprising moving the area of the demanded image and changing the subset accordingly.

13. The method of claim 8, comprising establishing an intensity of illumination for lamps within the area of the demanded image based at least in part on ambient light conditions.

14. The method of claim 8, comprising scaling the size of the area of the demanded image in response to user input representing a desired energy use such that which lamps that are maintained deenergized are defined at least in part using the user input.

15. Apparatus comprising:
TV tuner;
control circuitry receiving a demanded image from the TV tuner;
liquid crystal display (LCD) coupled to the control circuitry to present the demanded image, wherein
the control circuitry establishes a backlighting of the LCD in response to an area encompassed by the demanded image when displayed on the LCD.

16. The apparatus of claim 15, wherein the LCD comprises:
elongated co-planar lamps;
a matrix of LCD cells juxtaposed with the lamps, the lamps providing backlighting for the matrix, the control circuitry maintaining lamps outside the area encompassed by the demanded image deenergized.

17. The apparatus of claim 16, wherein the lamps are oriented vertically or horizontally.

18. The apparatus of claim 16, wherein the area of the demanded image is periodically shifted, the control circuitry changing which lamps are maintained deenergized in accordance with the image area.

19. The apparatus of claim 16, wherein the control circuitry establishes an intensity of illumination for lamps within the area encompassed by the demanded image based at least in part on ambient light conditions.

20. The apparatus of claim 16, wherein the control circuitry scales the area encompassed by the demanded image in response to user input representing a desired energy use such that which lamps that are maintained deenergized are defined at least in part using the user input.
